(19) United States
(12) Patent Application Publication
(10) Pub. No.: US 2008/0101200 A1
(43) Pub. Date: May 1, 2008

(54) OPTICAL PICKUP DEVICE AND OPTICAL DISC APPARATUS

(75) Inventor: Katsuyoshi Sato, Tokyo (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 11/929,303

(22) Filed: Oct. 30, 2007

(30) Foreign Application Priority Data
Oct. 31, 2006 (JP) 2006/295822

(51) Int. Cl. G11B 7/135

(52) U.S. Cl. 369/112.01

(57) ABSTRACT

An optical pickup device includes an optical pickup base having an opening through which reflected light from an optical disc passes to the outside, a light-receiving element shaped like a substantially rectangular plate and configured to convert the reflected light passing through the opening into an electrical signal, and a holder configured to hold the light-receiving element while surrounding a side face of the light-receiving element and attached in contact with an outer wall around the opening so that a light-receiving surface of the light-receiving element faces the opening. The optical pickup base and the holder are formed so that the holder can slide along a first axis parallel to the outer wall, and the holder is formed so that the light-receiving element can slide along a second axis perpendicular to the outer wall and a third axis orthogonal to the first axis and parallel to the outer wall.

### CROSS-REFERENCE TO RELATED APPLICATIONS

This application claims the benefit of priority of Japanese Patent Application No. 2006-295822, filed Oct. 31, 2006, the entire contents of which are incorporated herein by reference.

### BACKGROUND

1. Field

The present invention relates to an optical pickup device and an optical disc apparatus, and more particularly, to an optical pickup that irradiates laser light onto an optical disc and detects reflected light from the optical disc, and an optical disc apparatus including the optical pickup device.

2. Description of the Related Art

In recent years, optical disc apparatuses have been widely used in various types of information processing apparatuses and audiovisual apparatuses. The optical disc apparatuses include an optical pickup device. An optical disc is rotated by a spindle motor, and the optical pickup device is driven in the radial direction of the optical disc.

The optical pickup device includes a semiconductor laser for emitting laser light, an objective lens for focusing the laser light onto a recording surface of the optical disc, a light-collecting lens for collecting reflected light from the optical disc, and a light-receiving element for converting the collected reflected light into electrical signals. The optical pickup device also includes optical components that guide the laser light from the semiconductor laser to the objective lens, and conversely, guide the reflected light from the optical disc to the light-receiving element.

These components are fixed to or stored in an optical pickup base serving as a structural frame of the optical pickup device.

For recording and playback of an optical disc, it is important to set the optical axis of the objective lens to be perpendicular to the recording surface of the optical disc, and to precisely focus the objective lens on the recording surface of the optical disc.

It is similarly important to set the optical axis of the light-collecting lens to be perpendicular to a light-receiving surface of the light-receiving element, and to precisely focus the light-collecting lens on the light-receiving surface of the light-receiving element.

For this reason, high accuracy is required to mount the components on the optical pickup base in the optical pickup device. Further, it is necessary to prevent the mounting positions of the components from being displaced by an environmental change, such as a temperature change, or a lapse of operating time after mounting.

JP-A 2006-127586 discloses one technique of satisfying the above-described requirements. This technique relates to mounting of an actuator in a housing of an optical pickup device. In this technique, even if the actuator thermally expands, a force of the actuator for pushing side walls of the housing outward is reduced so as to suppress displacement of the components stored in the housing.

Hitherto, the light-receiving element has been joined to the optical pickup base by bonding with an adhesive.

More specifically, first, the light-receiving element is gripped with an appropriate jig before bonding, and the optimum mounting position of the light-receiving element is adjusted. In this case, the optimum mounting position is located and determined while actually receiving laser light and monitoring signals output from the light-receiving element. With this state maintained, a quick drying and hardening adhesive, such as a UV-hardening adhesive, is applied and hardened, for example, at four corners of the light-receiving element.

While the above-described method is simple and easy, the adhesive provided between the four corners of the light-receiving element and a surface of an outer wall of the optical pickup base is used as a support structure for the light-receiving element.

For this reason, the adhesive expands or contracts because of an environmental change, such as a temperature change, and or a lapse of time, or is affected by residual stress. Consequently, the mounting position of the light-receiving element sometimes deviates from the optimum one which was set at the time of bonding.

### SUMMARY OF THE INVENTION

The present invention has been made in view of the above-described circumstances, and an object of the invention is to provide an optical pickup device and an optical disc apparatus in which a mounting position of a light-receiving element can be prevented from being displaced after the light-receiving element is joined to an optical pickup base, regardless of an environmental change, such as a temperature change, and a lapse of time.

In order to overcome the above-described problems, an optical pickup device according to an aspect of the present invention includes an optical pickup base including a light-emitting element configured to emit laser light, an objective lens configured to collect the emitted laser light onto a recording surface of an optical disc, a light-collecting lens configured to collect reflected light guided from the optical disc via the objective lens, and an opening through which the collected reflected light passes to the outside; a light-receiving element shaped like a substantially rectangular plate and configured to convert the reflected light passing through the opening into an electrical signal; and a holder configured to hold the light-receiving element such as to surround a side face of the light-receiving element, the holder being attached in contact with an outer wall around the opening so that a light-receiving surface of the light-receiving element faces the opening. The optical pickup base and the holder are formed so that the holder can slide within a predetermined range in a first axial direction parallel to the outer wall, and the holder is formed so that the light-receiving element can slide within a predetermined range in a second axial direction perpendicular to the outer wall and a third axial direction orthogonal to the first axial direction and parallel to the outer wall.

An optical disc apparatus according to another aspect of the present invention includes a rotating unit configured to rotate an optical disc; an optical pickup device configured to emit laser light onto the optical disc and to output reflected light from the optical disc as an electrical signal; a radial driving unit configured to move the optical pickup device in the radial direction of the optical disc; and a reproduction unit configured to reproduce recording data from the electrical signal output from the optical pickup device. The optical pickup device includes an optical pickup base including a light-emitting element configured to emit the laser light, an objective lens configured to collect the emitted laser light onto a recording surface of the optical disc, a light-collecting lens configured to collect reflected light guided from the optical disc via the objective lens, and an opening through which the collected reflected light passes to the outside; a light-receiving element shaped like a substantially rectangular plate and configured to convert the reflected light passing through the opening into an electrical signal; and a holder configured to hold the light-receiving element such as to surround a side face of the light-receiving element, the holder being attached in contact with an outer wall around the opening so that a light-receiving surface of the light-receiving element faces the opening. The optical pickup base and the holder are formed so that the holder can slide within a predetermined range in a first axial direction parallel to the outer wall, and the holder is formed so that the light-receiving element can slide within a predetermined range in a second axial direction perpendicular to the outer wall and a third axial direction orthogonal to the first axial direction and parallel to the outer wall.

According to the optical pickup device and the optical disc apparatus of the present invention, after the light-receiving element is joined to the optical pickup base, the mounting position of the light-receiving element can be prevented from displacement, regardless of an environmental change, such as a temperature change, and a lapse of time.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

FIG. 1 is a plan view showing an external appearance of an optical disc apparatus according to an embodiment of the present invention;

FIG. 2 is a plan view showing an external appearance of an optical pickup device according to the embodiment;

FIG. 3 is a bottom view showing the external appearance of the optical pickup device;

FIG. 4 is an exploded perspective view showing a mounting structure for a light-receiving element;

FIG. 5 is an exploded perspective view showing details of the mounting structure for the light-receiving element;

FIGS. 6A to 6C are explanatory views showing a method for adjusting a mounting position of the light-receiving element in the height direction;

FIGS. 7A to 7C are explanatory views showing a method for adjusting the mounting position of the light-receiving element in the depth direction;

FIGS. 8A to 8C are explanatory views showing a method for adjusting the mounting position of the light-receiving element in the width direction;

FIG. 9 is an explanatory view showing a state before bonding in a fixing method for the light-receiving element;

FIG. 10 is an explanatory view showing a state after bonding in the fixing method for the light-receiving element; and

FIGS. 11A and 11B are explanatory views showing a known mounting structure and method for a light-receiving element.

### DETAILED DESCRIPTION

An optical pickup device and an optical disc apparatus according to an embodiment of the present invention will be described with reference to the attached drawings.

### (1) Configurations of Optical Disc Apparatus and Optical Pickup Device

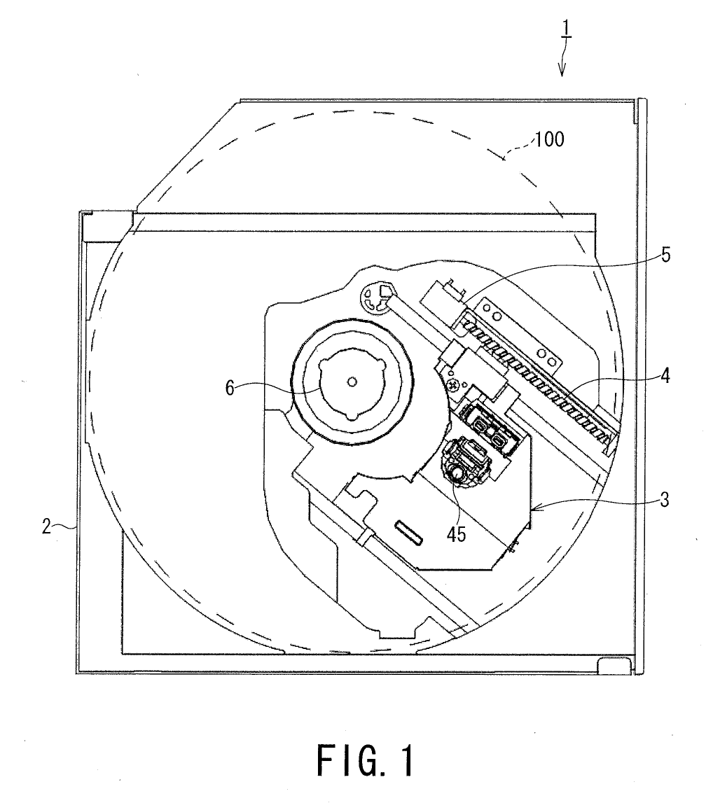

FIG. 1 is a plan view showing an external appearance of an optical disc apparatus 1 according to an embodiment of the present invention. In the optical disc apparatus 1, various components are housed in a thin case 2 having a substantially square shape. The case 2 can be mounted in information processing apparatuses, such as a personal computer, and various audiovisual apparatuses.

The optical disc apparatus 1 also includes a rotating unit (not shown). During playback or recording, an optical disc 100 is rotated at high speed with its center hole fitted on a projection 6 provided at the center of the optical disc apparatus 1.

An optical pickup device 3 is provided in the optical disc apparatus 1. Laser light is emitted from an objective lens 45 provided at almost the center of the optical pickup device 3 onto a recording surface of the optical disc 100.

A radial driving unit including a screw shaft 4 and a feeding motor 5 is also provided in the optical disc apparatus 1. The radial driving unit drives the optical pickup device 3 in the radial direction of the optical disc 100.

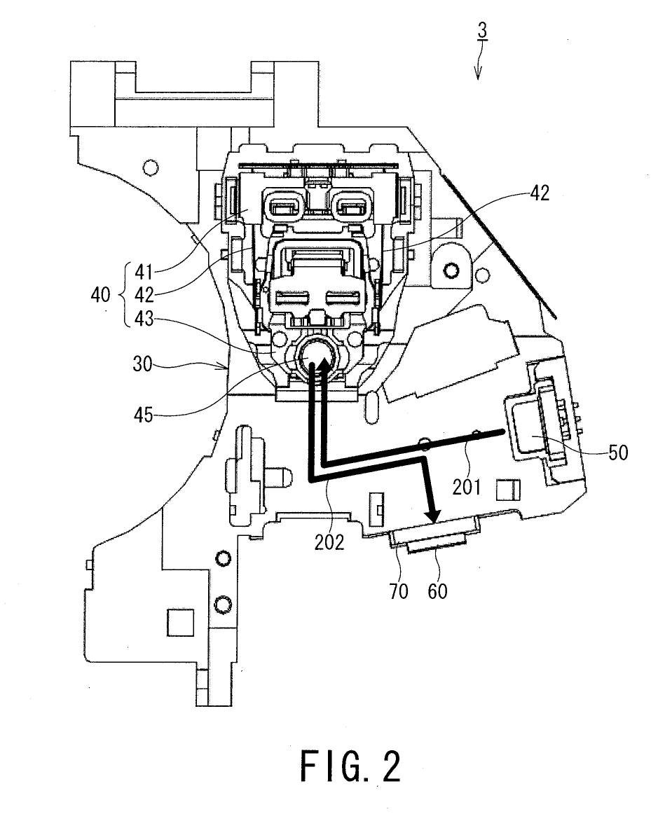

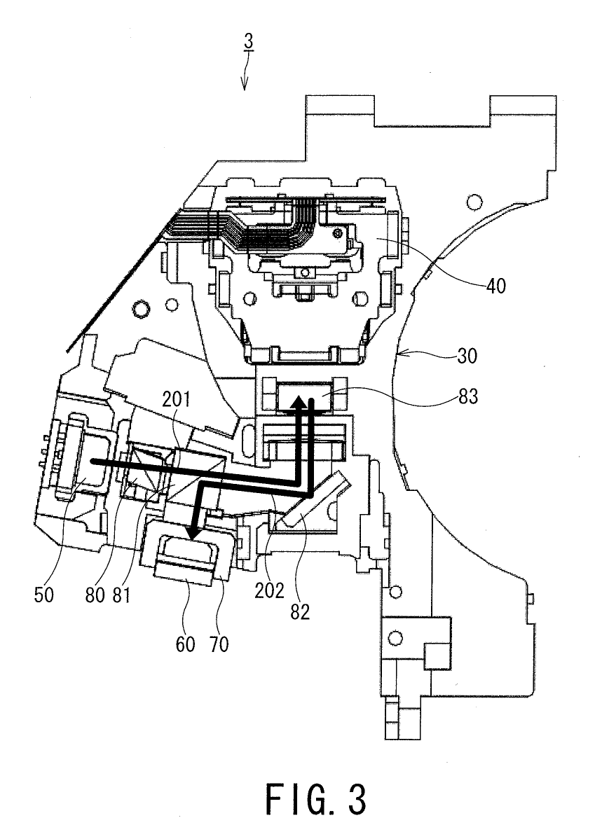

FIGS. 2 and 3 show an external appearance of only the optical pickup device 3 in the optical disc apparatus 1. FIG. 2 is an external plan view of the optical pickup device 3, as viewed from a surface facing the recording surface of the optical disc 100 (hereinafter referred to as a front surface), and FIG. 3 is an external bottom view of the optical pickup device 3, as viewed from a surface opposite the front surface.

The overall shape of the optical pickup device 3 is substantially determined by the shape of an optical pickup base 30. The optical pickup base 30 functions as a structural member of the optical pickup device 3. An actuator 40, a light-emitting element 50, a light-receiving element 60, and other optical components are mounted on the optical pickup base 30. The optical pickup base 30 is formed of, for example, a light metal such as aluminum, and can move at high speed in the radial direction of the optical disc 100.

The actuator 40 is provided in a region extending from a center portion to an upper portion of the optical pickup base 30 in FIG. 2. The actuator 40 includes a fixed portion 41 and a movable portion 43. The movable portion 43 is suspended by a plurality of suspension wires 42 extending from the fixed portion 41.

While a detailed description of the structure of the actuator 40 is omitted, the fixed portion 41 and the movable portion 43 include a plurality of magnets and a plurality of coils opposing each other. By controlling currents to be applied to the coils, electromagnetic forces generated by the currents of the coils and magnetic flux of the magnets are controlled so as to change the position of the movable portion 43 relative to the fixed portion 41. As a result, the position of the objective lens 45 fixed to the leading end of the movable portion 43 can be slightly changed relative to the recording surface of the optical disc 100. This realizes servo control in the focus direction (a direction perpendicular to the recording surface) and in the tracking direction (the radial direction of the optical disc 100).

The light-emitting element 50 is fixed near the right end of the optical pickup base 30 shown in FIG. 2. The light-emitting element 50 is formed by, for example, a laser semiconductor device, and emits laser light with an intensity in accordance with the driving current output from the optical disc apparatus 1.

As shown by an irradiation light path 201 in FIG. 3, laser light output from the light-emitting element 50 passes through a first prism 80 and a second prism 81, and the optical path thereof is deflected toward the objective lens 45 by a mirror 82 and is further deflected toward the recording surface of the optical disc 100 by a raising mirror 83. Then, the laser light passes through the objective lens 45, and is focused onto the recording surface of the optical disc 100.

The light-receiving element 60 is fixed to a lower portion of the optical pickup base 30 in FIG. 2 or 3 with a holder 70 disposed therebetween. The light-receiving element 60 includes, for example, a photodiode, and converts reflected light into electrical signals.

After reflected by the recording surface of the optical disc 100, the laser light propagates along a reflected light path 202 opposite the irradiation light path 201, and is deflected toward the light-receiving element 60 by the second prism 81. Then, the laser light is collected by a light-collecting lens (not shown), and reaches a light-receiving surface of the light-receiving element 60.

The light-receiving surface of the light-receiving element 60 is split into a plurality of sections. The optical disc apparatus 1 generates a focus error signal, a tracking error signal, and the like on the basis of electrical signals output from these sections. The actuator 40 is controlled according to the focus error signal, the tracking error signal, and the like.

The electrical signals output from the light-receiving element 60 are input to a reproduction unit (not shown) provided in the optical disc apparatus 1 so that data recorded on the optical disc 100 is reproduced.

### (2) Mounting Structure for Light-Receiving Element

The mounting position of the light-receiving element 60 is extremely important in ensuring high performance of the optical disc apparatus 1. If the light-receiving element 60 is mounted at an improper position, not only the quality of a reproduction signal from the optical disc 100 is lowered, but also focus servo and tracking servo control operations of the actuator 40 are not performed properly.

For this reason, high accuracy is required to mount the light-receiving element 60 on the optical pickup base 30. More specifically, the light-receiving element 60 is gripped with an appropriate jig before mounting, and the optimum mounting position of the light-receiving element 60 is adjusted. In this case, the optimum mounting position is located and determined while actually receiving the laser light and monitoring signals output from the light-receiving element 60. After the optimum mounting position is determined, the light-receiving element 60 is fixed by bonding with a quick drying and hardening adhesive, such as a UV adhesive, while maintaining this state.

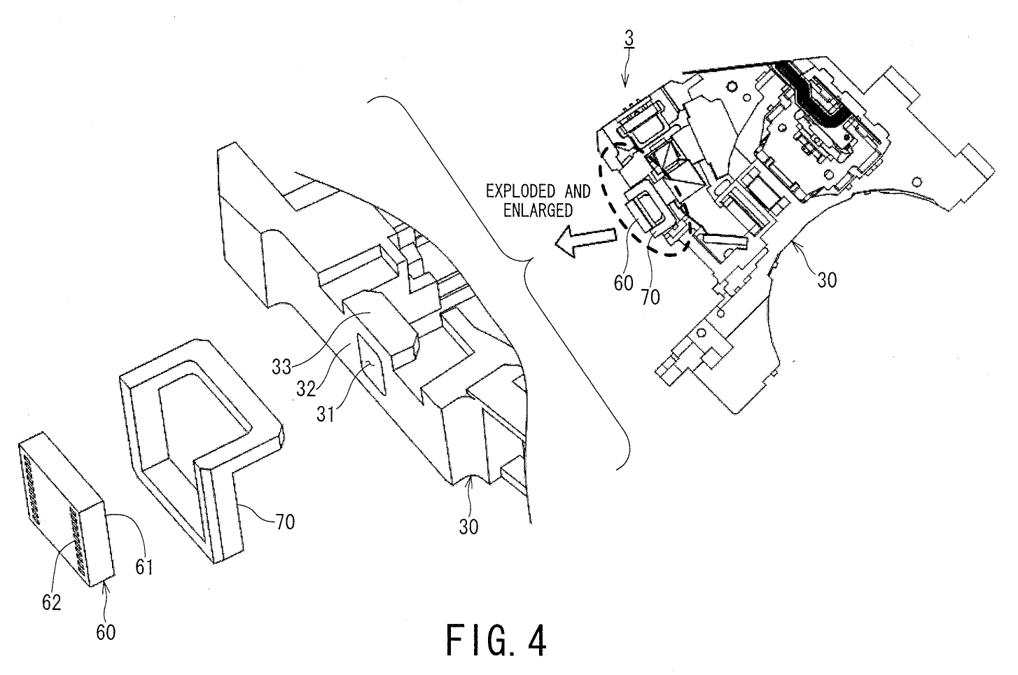

FIG. 4 is an exploded perspective view showing a mounting structure for the light-receiving element 60 in this embodiment. In FIG. 4, the holder 70 and the light-receiving element 60 are dismounted from the optical pickup base 30.

An opening 31 through which reflected light is output is provided in a part of the outer periphery of the optical pickup base 30. The light-receiving element 60 is mounted so that a light-receiving surface 61 thereof faces the opening 31.

As shown in FIG. 4, a plurality of electrodes 62 are provided on a back surface of the light-receiving element 60 (a surface opposite the light-receiving surface 60). The electrical signals converted from reflected light are output from the electrodes 62 to the reproduction unit and the like in the optical disc apparatus 1 via a flexible cable (not shown) connected to the electrodes 62.

The mounting structure and method for the light-receiving element 60 in this embodiment are characterized in that the light-receiving element 60 is not directly bonded to an outer wall 32 around the opening 30, but is fixed thereto via the holder 70. That is, the light-receiving element 60 and the holder 70 are fixed with an adhesive or the like, and the holder 70 and the outer wall 32 of the optical pickup base 30 are fixed with an adhesive or the like. Further, the holder 70 is fitted on a projection 33 provided at the top of the outer wall 32.

While operational advantages of this mounting structure for the light-receiving element 60 will be described below, a mounting structure and a mounting method for the light-receiving element 60 that have hitherto been popularly used will now be described briefly.

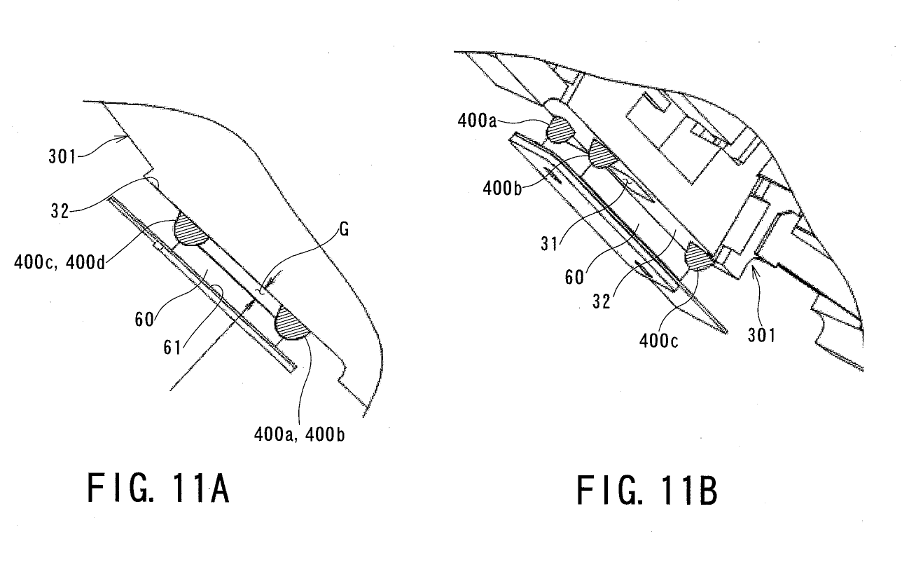

FIGS. 11A and 11B show an example of a known mounting structure and method for a light-receiving element 60 (a part of a flexible cable is connected to the light-receiving element 60).

After the optimum mounting position is determined, for example, UV-hardening adhesives 400a, 400b, 400c, and 400d are applied to four corners of the light-receiving element 60. The light-receiving element 60 is fixed to an outer wall 32 around an opening 31 by hardening of the adhesives 400a, 400b, 400c, and 400d. The hardened adhesives 400a, 400b, 400c, and 400d serve as support structures for the light-receiving element 60, and are interposed between the light-receiving element 60 and the outer wall 32 so as to form a gap G therebetween.

In the above-described mounting structure and method, the optimum mounting position can be ensured immediately after the light-receiving element 60 is mounted, but the mounting position and mounting angle easily change with time and an environmental change. The adhesives 400a, 400b, 400c, and 400d serving as the support structures expand or contract by the influence of temperature or the like, or are affected by residual stress. As a result, the optimum mounting position and angle sometimes deviate from the optimum ones which were set when bonding the light-receiving element 60.

The mounting structure for the light-receiving element 60 shown in FIG. 4 according to this embodiment is effective in avoiding this problem.

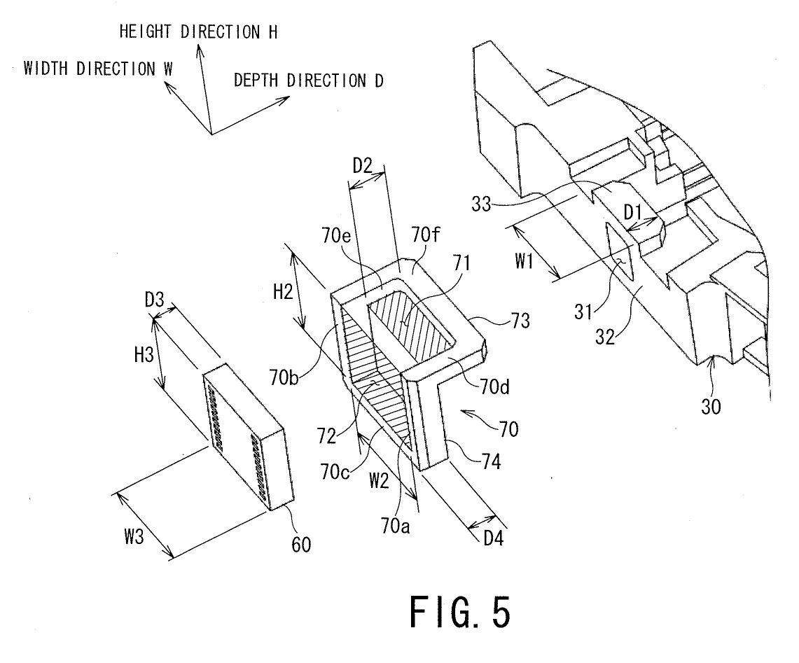

FIG. 5 is an exploded perspective view showing details of the mounting structure shown in FIG. 4. In FIG. 5, the coordinate systems are also defined by three orthogonal axes. The thickness direction of the light-receiving element 60 is designated as a depth direction D (a second axial direction), the width direction is designated as a width direction W (a first axial direction), and the height direction is designated as a height direction H (a third axial direction). The following description will be given according to the definitions of the coordinate systems.

Above the opening 31 of the optical pickup base 30, the projection 33 projects from an upper edge of the outer wall 32 toward the inside of the optical pickup base 30. The projection 33 has a depth D1 and a width W1, and is formed integrally with the optical pickup base 30, for example, by a light metal such as aluminum.

The holder 70 is shaped by perpendicularly bending a frame-shaped rectangular member in the depth direction at a middle portion in the height direction. The holder 70 includes an upper frame portion 73 extending in the depth direction, and a lower frame portion 74 extending in the height direction.

In the upper frame portion 73, a first rectangular opening 71 is defined by three upper frames 70d, 70e, and 70f. In the lower frame portion 74, a second rectangular opening 72 is defined by three lower frames 70a, 70b, and 70c.

The holder 70 is attached to the optical pickup base 30 in a manner such that the first rectangular opening 71 is fitted on the projection 33 of the optical pickup base 30.

The first rectangular opening 71 has a depth D2 and a width W2, and the depth D2 is substantially equal to the depth D1 of the projection 33 (that is, D2=D1).

As a result, after the first rectangular opening 71 of the holder 70 is fitted on the projection 33, movement of the holder 70 in the depth direction is restrained, and the mounting position of the holder 70 in the depth direction does not change relative to the optical pickup base 30.

The width W2 of the first rectangular opening 71 is larger than the width W1 of the projection 33 by a predetermined margin m1 (that is, W2=W1+m1>W1).

Therefore, even after the first rectangular opening 71 is fitted on the projection 33, the holder 70 can slide within the margin m1 in the width direction.

When the projection 33 and the first rectangular opening 71 are fitted together, the outer wall 32 and an upper face thereof are brought into tight contact with opposing surfaces of the upper frames 70d and 70e and the lower frames 70a and 70b of the holder 70. Therefore, the attitude angle (mounting angle) of the holder 70 also does not change relative to the optical pickup base 30.

On the other hand, the width W2 of the second rectangular opening 72 of the holder 70 (equal to the width W2 of the first rectangular opening 71) is substantially equal to the width W3 of the light-receiving element 60 (that is, W2=W3).

Further, the height H2 of the second rectangular opening 72 is larger than the height H3 of the light-receiving element 60 by a predetermined margin m2 (that is, H2=H3+m2>H3).

As a result, after the light-receiving element 60 is fitted in the second rectangular opening 72 of the holder 70, movement of the light-receiving element 60 in the width direction is restrained, and the mounting position of the light-receiving element 60 in the width direction does not change relative to the holder 70. In contrast, the light-receiving element 60 can slide in the height direction, and can translate relative to the holder 70 within the margin m2.

Further, the light-receiving element 60 can slide in the depth direction of the holder 70 even after fitted in the second rectangular opening 72, and can translate within the depth D4 of the lower frames 70a, 70b, and 70c of the holder 70.

In this case, side faces of the light-receiving elements 60 are in tight contact with inner faces of the lower frames 70a and 70b. Therefore, the attitude angle (mounting angle) of the light-receiving element 60 does not change relative to the holder 70.

While the material of the holder 70 is not particularly limited, the holder 70 may be formed of the same light metal for the optical pickup base 30, for example, aluminum.

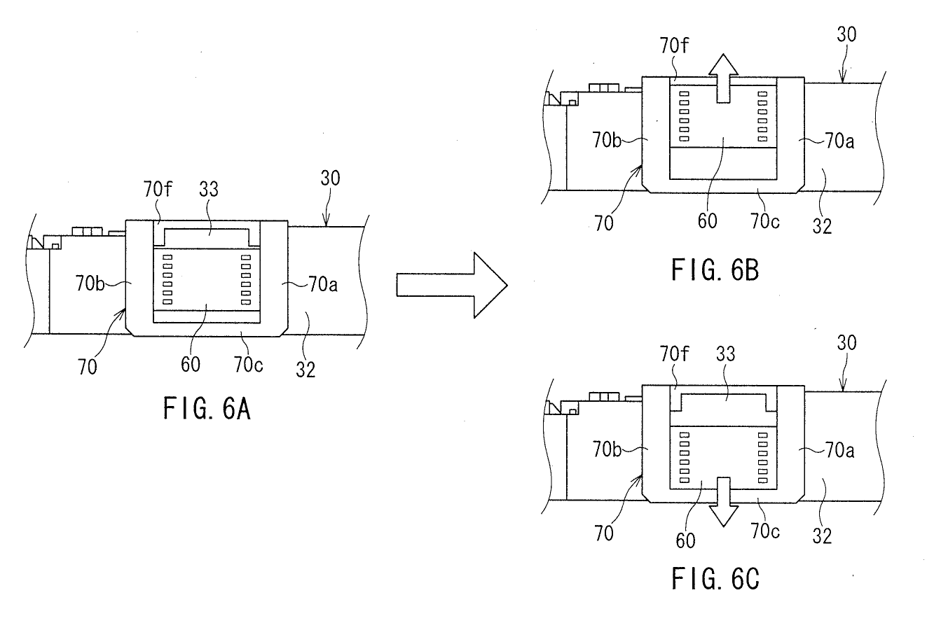

FIGS. 6 to 8 explain methods for adjusting the mounting position of the light-receiving element 60. In any method, the holder 70 and the light-receiving element 60 are moved while being held by a jig (not shown), and the optimum mounting position is determined while monitoring electrical signals output from the light-receiving element 60.

In FIGS. 6A to 6C, after the holder 70 is fitted on the projection 33 of the optical pickup base 30, the light-receiving element 60 is fitted in the second rectangular opening 72 of the holder 70, and the position thereof is then adjusted in the height direction. FIG. 6A shows a state in which the light-receiving element 60 is placed at almost the center in the height direction, and FIGS. 6B and 6C respectively show states in which the light-receiving element 60 is slid relative to the holder 70 in the positive and negative height directions.

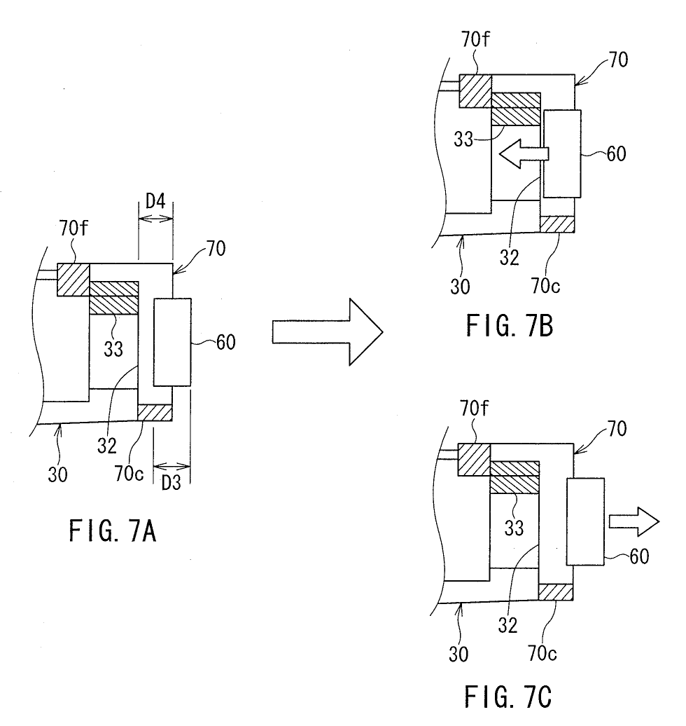

In FIGS. 7A to 7C, the position of the light-receiving element 60 is adjusted in the depth direction. FIG. 7A shows a state in which the light-receiving element 60 is placed at almost the center in the depth direction, and FIGS. 7B and 7C respectively show states in which the light-receiving element 60 is slid relative to the holder 70 in the positive and negative depth directions.

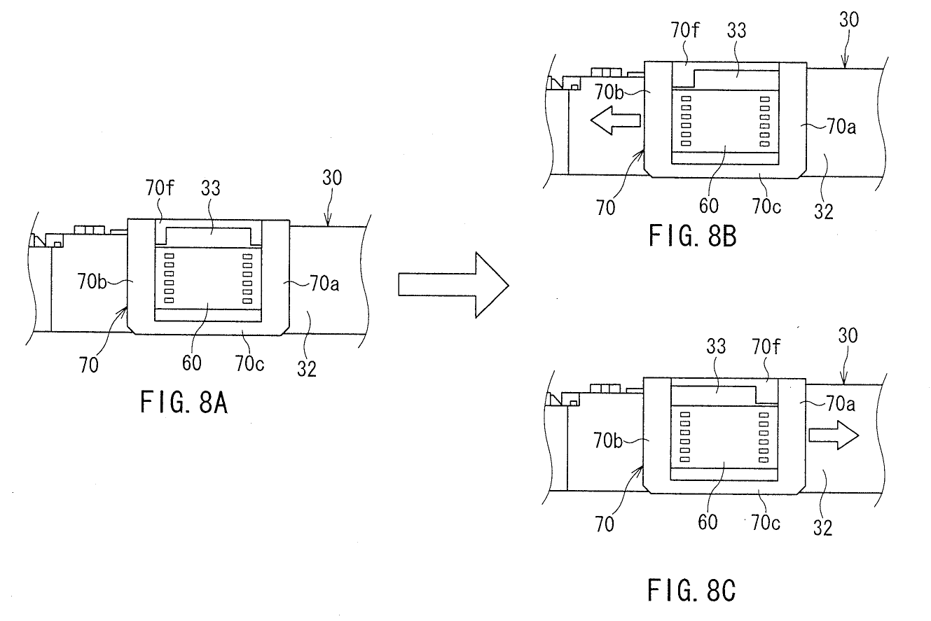

In the adjustment methods shown in FIGS. 6A to 6C and FIGS. 7A to 7C, the mounting position of the light-receiving element 60 is adjusted by sliding the light-receiving element 60 in the height direction and the depth direction while the holder 70 is fixed to the optical pickup base 30. In contrast, in order to adjust the light-receiving element 60 in the width direction, the relative positions of the light-receiving element 60 and the holder 70 are fixed, and the holder 70 is slid relative to the optical pickup base 30, as shown in FIGS. 8A to 8C.

FIG. 8A shows a state in which the holder 70 is placed at almost the center in the width direction, and FIGS. 8B and 8C respectively show states in which the holder 70 is slid relative to the optical pickup base 30 in the positive and negative width directions.

In this way, the optimum mounting position can be located and determined by sliding the light-receiving element 60 along the three axes.

After the optimum mounting position of the light-receiving element 60 is determined, the holder 70 and the light-receiving element 60 are fixed to the optical pickup base 30 with an adhesive or the like.

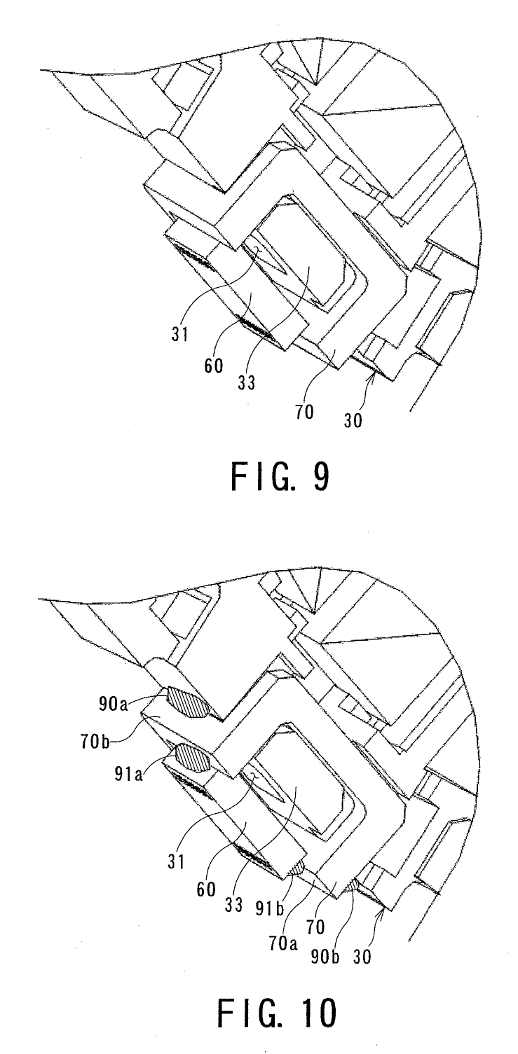

FIG. 9 shows a state after the optimum mounting position is determined and before bonding is performed, and FIG. 10 shows a state after bonding is performed with an adhesive.

Quick-drying and hardening adhesives, such as UV-hardening adhesives, 90a and 90b are applied to two contact points between the lower frames 70a and 70b of the holder 70 and the outer wall 32. Further, UV-hardening adhesives 91a and 91b are applied to two contact points between the lower frames 70a and 70b of the holder 70 and the side faces of the light-receiving element 60. This bonding at four points allows the light-receiving element 60 to be fixed to the optical pickup base 30 with the holder 70 disposed therebetween. The number and positions of the points where the adhesive is applied are not limited to those shown in FIG. 10.

The mounting structure of this embodiment (FIG. 10) and the known mounting structure (FIG. 11) will now be compared. While the adhesive serves as the support structure for the light-receiving element 60 in the known mounting structure, the holder 70 formed of aluminum or the like serves as the support structure for the light-receiving element 60 in this embodiment. In this embodiment, the adhesive chiefly aims to prevent the holder 70 and the light-receiving element 60 from being slightly slid by a temperature change after the positions thereof are adjusted by sliding along the three axes, that is, the adhesive does not serve as the support structure.

For this reason, even if the adhesive expands or contracts due to a lapse of time or a temperature change after bonding, it does not directly change the mounting position and mounting angle of the light-receiving element 60. Therefore, the optical disc apparatus 1 can maintain stable performance for a long time.

Since the light-receiving element 60 is moved only along the three orthogonal axes when adjusting the optimum mounting position thereof, adjustment can be made stably and accurately.

The present invention is not limited to the above-described embodiments, and can be carried out by modifying the components within the scope of the invention. The present invention also can be carried out by appropriately combining a plurality of components in each embodiment. For example, some of the components described in the embodiment may be omitted. Further, the components in different embodiments may be combined appropriately.

What is claimed is:

1. An optical pickup device comprising:
an optical pickup base comprising a light-emitting element configured to emit laser light, an objective lens configured to focus the emitted laser light onto a recording surface of an optical disc, a light-collecting lens configured to collect reflected light guided from the recording surface of the optical disc via the objective lens, and an opening in the optical pickup base configured to allow the collected reflected light to pass through;
a light-receiving element comprising a substantially rectangular plate and a light-receiving surface facing the opening, the light receiving element configured to convert the collected reflected light into an electrical signal when the collected reflected light passes through the opening; and
a holder configured to hold the light-receiving element, the holder being in contact with an outer wall around the opening of the optical pickup base;
wherein the optical pickup base and the holder are configured such that the holder can slide within a predetermined range in a first axial direction parallel to the outer wall, and the light-receiving element can slide within a predetermined range in a second axial direction perpendicular to the outer wall and a third axial direction orthogonal to the first axial direction and parallel to the outer wall.

2. The optical pickup device according to claim 1,
wherein the optical pickup base includes a projection extending from the outer wall in a direction opposite the surface of the outer wall, and
wherein the holder includes a first rectangular opening configured to fit the projection, and a second rectangular opening configured to hold the light-receiving element.

3. The optical pickup device according to claim 2,
wherein the first rectangular opening is longer than the projection in the first axial direction by a predetermined margin so that the holder can slide within the margin in the first axial direction, and
wherein the first rectangular opening is substantially equal to the projection in length in the second axial direction so as to restrain movement of the holder in the second axial direction.

4. The optical pickup device according to claim 2,
wherein the second rectangular opening is longer than the light-receiving element by a predetermined margin so that the light-receiving element can slide within the margin in the third axial direction and can slide in the second axial direction, and
wherein the second rectangular opening is substantially equal to the light-receiving element in length in the first axial direction so as to restrain movement of the light-receiving element relative to the holder in the first axial direction.

5. The optical pickup device according to claim 1, wherein the light receiving element is configured to be positioned by sliding the holder in the first axial direction, and by being slid within the holder in the second axial direction and the third axial direction, and wherein the holder is configured to be fixed to the outer wall of the optical pickup base with an adhesive and the light-receiving element is configured to be fixed to the holder with an adhesive when the holder and the light-receiving element are positioned.

6. An optical disc apparatus comprising:
a rotating unit configured to rotate an optical disc;
an optical pickup device configured to emit laser light onto the optical disc and to output reflected light from the optical disc as an electrical signal;
a radial driving unit configured to move the optical pickup device in a radial direction of the optical disc; and
a reproduction unit configured to reproduce recording data from the electrical signal output from the optical pickup device,
wherein the optical pickup device comprises:
an optical pickup base comprising a light-emitting element configured to emit the laser light, an objective lens configured to focus the emitted laser light onto a recording surface of the optical disc, a light-collecting lens configured to collect the reflected light guided from the recording surface of the optical disc via the objective lens, and an opening in the optical pickup base configured to allow the collected reflected light to pass through;
a light-receiving element comprising a substantially rectangular plate and a light-receiving surface facing the opening, the light receiving element configured to convert the collected reflected light into the electrical signal when the collected reflected light passes through the opening; and
a holder configured to hold the light-receiving element, the holder being in contact with an outer wall around the opening of the optical pickup base; wherein the optical pickup base and the holder are configured such that the holder can slide within a predetermined range in a first axial direction parallel to the outer wall, and the light-receiving element can slide within a predetermined range in a second axial direction perpendicular to the outer wall and a third axial direction orthogonal to the first axial direction and parallel to the outer wall.

7. The optical disc apparatus according to claim 6,
wherein the optical pickup base includes a projection extending from the outer wall in a direction opposite the surface of the outer wall, and
wherein the holder includes a first rectangular opening configured to fit the projection, and a second rectangular opening configured to hold the light-receiving element.

8. The optical disc apparatus according to claim 7,
wherein the first rectangular opening is longer than the projection in the first axial direction by a predetermined margin so that the holder can slide within the margin in the first axial direction, and
wherein the first rectangular opening is substantially equal to the projection in length in the second axial direction so as to restrain movement of the holder in the second axial direction.

9. The optical disc apparatus according to claim 7,
wherein the second rectangular opening is longer than the light-receiving element in the third axial direction by a predetermined margin so that the light-receiving element can slide within the margin in the third axial direction and can slide in the second axial direction, and
wherein the second rectangular opening is substantially equal to the light-receiving element in length in the first axial direction so as to restrain movement of the light-receiving element relative to the holder in the first axial direction.

10. The optical disc apparatus according to claim 6, wherein the light receiving element is configured to be positioned by sliding the holder in the first axial direction, and by being slid within the holder in the second axial direction and the third axial direction, and wherein the holder is configured to be fixed to the outer wall of the optical pickup base with an adhesive and the light-receiving element is configured to be fixed to the holder with an adhesive after the holder and the light-receiving element are positioned.
